(19) United States
(12) Patent Application Publication
(10) Pub. No.: US 2006/0151097 A1
(43) Pub. Date: Jul. 13, 2006

(54) METHOD OF MAKING A NON-CARPETED FLOOR COVERING

(76) Inventors: Norman H. Bennett, Clinton Township, MI (US); Kenneth R. Parrish, Roseville, MI (US); Theodore Peterson, Sheboygan Falls, SC (US)

Correspondence Address: WOOD, HERRON & EVANS, LLP (LEAR), 2700 CAREW TOWER, 441 VINE STREET, CINCINNATI, OH, 45202, US

(21) Appl. No.: 10/905,628

(22) Filed: Jan. 13, 2005

(51) Int. Cl. B32B 37/00

(52) U.S. Cl. 156/245; 156/308.2

(57) ABSTRACT

The present invention provides for an improved method of making non-carpeted floor coverings for vehicles. The method includes providing a non-carpeted floor covering blank having a precut non-carpeted flooring, precut under-pad, and precut adhesive layer. The adhesive layer is situated intermediate the non-carpeted flooring and under-pad. The blank is heated to join the non-carpeted flooring and under-pad to the adhesive layer to form an integrated blank. The integrated blank is molded into a desired shape then trimmed for use as a non-carpeted floor covering in a vehicle.

### FIELD OF THE INVENTION

The present invention pertains generally to carpet molding, and more particularly, to a method of making non-carpeted floor coverings for vehicles.

### BACKGROUND OF THE INVENTION

It is known to provide vehicle interiors with non-carpeted floor coverings. Current automobile floor coverings are typically molded, laminated products that include a non-carpet layer having a thermoplastic material laminated to a back surface. Either prior to or after the non-carpet layer has been molded to conform to the flooring, for example, of an automobile, a plastic or fibrous material blend, such as an under-pad or decoupler, is bonded thereto.

Typically, these automotive non-carpeted floor coverings are constructed in at least a two-step process that requires the molding or die cutting of the underpad. The molded or die cut underpad is placed into a cavity in a tool. A non-carpeted layer then is heated and similarly placed into the cavity in the tool for molding to the underpad. Alternatively, the underpad and the non-carpet layer are formed, i.e. molded, separately then combined, such as by using an adhesive. Both processes, however, are expensive because they require separate under-pad tooling and multiple steps.

It would therefore be desirable to provide a method for forming non-carpet floor coverings that reduces the number of steps and eliminates the unnecessary tooling required to couple under-padding to non-carpeted material, thereby reducing costs associated therewith.

### SUMMARY OF THE INVENTION

The present invention provides for an improved method of making non-carpeted floor coverings for vehicles.

To this end, the method includes providing a precut non-carpeted flooring, an under-pad, and an adhesive layer. The precut layers are arranged wherein the adhesive layer is situated intermediate the non-carpeted flooring and the under-pad to form a non-carpeted floor covering blank. The blank is loaded at a loading station, for example, within a frame of a rotary vacuum former for continuous processing into a non-carpeted floor covering. The blank is moved from this loading station to a first oven to be preheated so that the non-carpeted flooring and underpad reach desired first target temperatures. The preheated blank then is moved to a second oven and again heated so that the non-carpeted flooring and underpad reach desired second target temperatures to join the non-carpeted flooring and under-pad to the adhesive layer to form an integrated blank.

The integrated blank then is moved from the second oven to a molding station wherein it undergoes vacuum forming and compression molding, and further is cooled, into a desired shape. After molding, the molded blank may be moved to a trimming station for trimming thereof to a desired dimension for use in a vehicle as a non-carpeted floor covering. In an exemplary embodiment, the non-carpeted flooring includes a polymeric material and the under-pad includes a thermoplastic fiber blend of polyethylene terephthalate.

By virtue of the foregoing, there is thus provided an improved method of making non-carpeted floor coverings for vehicles that eliminates the need for traditional tooling, such as underpad tooling, and reduces the number of processing steps, thereby reducing costs associated therewith.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is an exploded perspective view of a non-carpeted floor covering blank with precut layers for forming a non-carpeted floor covering in accordance with the present invention;

FIG. 2 is a schematic top plan view of a non-carpeted floor covering molding system for receiving the blank of FIG. 1 and forming a non-carpeted floor covering in accordance with the present invention;

FIG. 3A. is an elevational view of a non-carpeted floor covering made in accordance with the method of the present invention; and

FIG. 3B is a cross-sectional view of the non-carpeted floor covering of FIG. 3A.

### DETAILED DESCRIPTION OF THE DRAWINGS

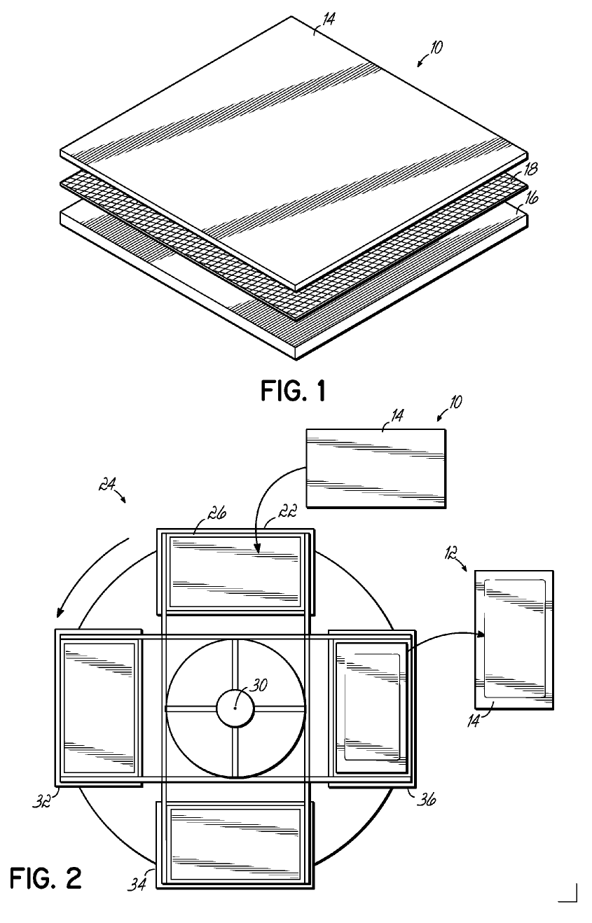

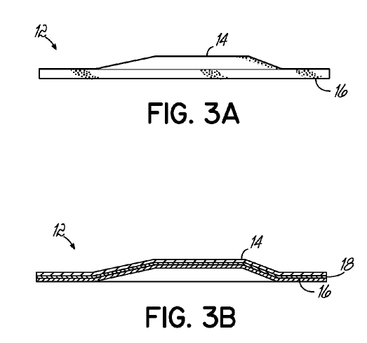

FIG. 1 shows a non-carpeted floor covering blank 10 for forming a non-carpeted floor covering 12 (See FIGS. 3A and 3B) in accordance with the present invention. The blank 10 includes a precut non-carpeted flooring 14, a precut under-pad 16, and a precut adhesive layer 18 wherein the adhesive layer 18 is situated intermediate the non-carpeted flooring 14 and the under-pad 16. Each precut layer 14, 16, 18 generally defines a sheet that may be originally processed from raw materials, for example, into a roll then cut therefrom, as is known in the art. The non-carpeted flooring 14 defines the top or A-surface that a consumer can observe after the non-carpeted floor covering 12 is installed into a vehicle (not shown) while the under-pad 16 defines the bottom or B-surface.

The non-carpeted flooring 14 may include a polymeric material, advantageously a thermoplastic material, such as TPO, PVC, EVA, and the like, and blends thereof. In addition, the non-carpeted flooring 14 may, or may not, include filler content, as is commonly known in the art. The under-pad 16, or decoupler, includes a thermoplastic material, advantageously, a thermoplastic fiber blend, and more advantageously a blend of polyethylene terephthalate (PET) fibers. One exemplary under-pad 16 is a product called CW (CoreWeb) available from Lear Corporation that includes a blend of PET fibers vertically oriented. The adhesive layer 18 may be heat activated, pressure-sensitive, etc. and can include any known adhesive such as an epoxy resin, acrylic, etc. This adhesive layer 18 may be provided as a webbed sheet. The precut layers 14, 16, 18 may include any desirable thickness for forming the non-carpeted floor covering 12. Advantageously, the non-carpeted layer 14 is about 1.5 to 2.0 mm, the under-pad 16 is no less than about 30-35 mm, and the adhesive layer 18 is about 0.076 to 0.13 mm.

Referring to FIG. 2, the non-carpeted floor covering blank 10 is situated adjacent a loading station 22, for example, of a rotary vacuum former 24, commonly known in the art. The blank 10 may be one of a plurality of blanks provided on a skid, or pallet, ready for processing into the non-carpeted floor covering 12 of the present invention. The blank 10 may be manually or automatically loaded by means, commonly known in the art, within a holding frame 26, or clamp, of the rotary vacuum former 24. Generally, the holding frame 26 with blank 10 is cycled about a central axis 30 in a continuous manner through a first oven 32, second oven 34, then a molding station 36 for processing. After molding, the blank 10 is removed from the molding station 36, such as for additional trimming thereof, and the empty frame 26 returns to the loading station 22 to begin the cycle anew.

More specifically, once loaded, the blank 10 is moved within the frame 26 from the loading station 22 to within the first oven 32. Typically, the first oven 32 and second oven 34 are infrared (IR) ovens including heating elements (not shown) for providing radiant heat to the blank 10. As is commonly known in the art, heat settings for these ovens 32, 34, such as for the heating elements, are controlled by adjusting the percentage of power based on a maximum temperature for the heating element(s). Separately controlled heating elements should be provided proximate the non-carpeted flooring 14 and the under-pad 16.

Inside the first oven 32, the blank 10 preferably is preheated so that the non-carpeted flooring 14 and under-pad 16 reach desired first target temperatures in a desired timeframe so as to avoid damaging, e.g. burning, the blank 10. In one exemplary embodiment, the blank 10 is preheated so that the non-carpeted flooring 14, preferably a blend of thermoplastic olefin, and the under-pad 16, preferably a blend of PET fibers vertically oriented, reach about 300° F. in no less than about 60 seconds. For an IR oven having a maximum temperature setting of about 1200° F., this is the equivalent of adjusting the power setting to about 20-25%. The adhesive layer 18 may include any suitable adhesive as indicated above.

After being preheated, the blank 10 then is moved to the second oven 34. Again, the second oven 34 typically is an infrared (IR) oven including heating elements (not shown) for providing radiant heat to the blank 10. Once inside the second oven 34, the blank 10 is again heated by the heating elements so that the non-carpeted flooring 14 and under-pad 16 reach desired second target temperatures in a desired timeframe to join the non-carpeted flooring 14 and under-pad 16 to the adhesive layer 18 to integrate the layers 14, 16, 18. More specifically, the blank 10 is heated so that the non-carpeted flooring 14, preferably a blend of a thermoplastic olefin, reaches about 280° F. and the under-pad 16, preferably a blend of PET fibers vertically oriented, reaches about 350° F. in no less than about 60 seconds. For an IR oven having a maximum temperature setting of about 1200° F., this is the equivalent of adjusting the power setting of the heating element for the non-carpeted flooring 14 to about 14-36% and the heating element for the under-pad 16 to about 15-40%. Again, the adhesive layer 18 may include any suitable adhesive as indicated above.

The blank 10 with layers 14, 16, 18 now integrated is moved from the second oven 34 to the molding station 36 which includes typical molding tools (not shown), as will be understood by one skilled in the art, wherein the blank 10 undergoes vacuum forming and compression molding, and further is cooled, into a desired shape. The vacuum molding, i.e. suction, is applied on the non-carpeted flooring 14 of the blank 10 while the compression molding, i.e. pressure, is applied to the under-pad 16 of the blank 10 with the vacuum molding generally beginning slightly prior to compression molding. Cooling of the blank 10 generally occurs during both processes, as is well known in the art, and preferably is intended to cool the blank 10 to a target temperature within a desired timeframe. Cooling of the blank 10 may be enhanced by pulling a vacuum through the compression molding tool. The vacuum and compression molding, along with the cooling of the blank 10, allows for molding thereof into a desired shape for use as the non-carpeted floor covering 12.

In an exemplary embodiment, the non-carpeted flooring 14, preferably a blend of a thermoplastic olefin, and the under-pad 16, preferably a blend of PET fibers vertically oriented, are cooled to about 100° F. in about 60 seconds during vacuum and compression molding. The adhesive layer 18 may be any suitable adhesive as indicated above. In addition, vacuum molding of the blank 10 preferably occurs at about 10 to 11 psi while compression molding preferably occurs at a pressure of about 2.5 to 3.0 psi, whereby the compressed under-pad 16 is reduced from about 30 to 35 mm to desired design intent thicknesses with a minimum thickness down to about 3 mm.

After molding, the blank 10, now shaped, may be removed from its holding frame 26 and may be transferred to a trimming station (not shown) for trimming thereof to a desired dimension, such as for use in a vehicle as the non-carpeted floor covering 12. This removal and transfer, along with the trimming, may be manually and/or automatically performed for continuous processing.

Accordingly, the formed non-carpeted floor covering 12, as best shown in FIGS. 3A and 3B, includes the non-carpeted flooring 14 defining the top or A-surface that a consumer sees after the non-carpeted floor covering 12 is installed while the under-pad 16 defines the bottom or B-surface. The adhesive layer 18 is integrated intermediate the flooring 14 and the under-pad 16. The non-carpeted floor covering 12 now may be secured to a floor of a vehicle (not shown), typically, after components (not shown) are installed, such as the seats, scuff plates, side cowls, and center console. Upon installation, dedicated fasteners (not shown) may be used whose sole function is to secure the floor covering 12 to the vehicle.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. A method of making a non-carpeted floor covering for a vehicle, comprising:
providing a non-carpeted floor covering blank including a precut non-carpeted flooring, precut under-pad, and precut adhesive layer, the adhesive layer being situated intermediate the non-carpeted flooring and under-pad;
heating the blank to join the non-carpeted flooring and under-pad to the adhesive layer to form an integrated blank; and
molding the integrated blank into a desired shape for use as a non-carpeted floor covering.

2. The method of claim 1 wherein the step of heating the blank to join the non-carpeted flooring and under-pad to the adhesive layer to form an integrated blank includes preheating the blank so that the non-carpeted flooring and underpad reach desired first target temperatures then heating the preheated blank so that the non-carpeted flooring and underpad reach desired second target temperatures to join the non-carpeted flooring and under-pad to the adhesive layer to form the integrated blank.

3. The method of claim 2 wherein the step of heating the blank to join the non-carpeted flooring and under-pad to the adhesive layer to form an integrated blank includes preheating the blank so that the non-carpeted flooring and underpad reach desired first target temperatures in no less than about 60 seconds then heating the preheated blank so that the non-carpeted flooring and underpad reach desired second target temperatures in no less than about 60 seconds to join the non-carpeted flooring and under-pad to the adhesive layer to form the integrated blank.

4. The method of claim 1 wherein the step of molding the integrated blank into a desired shape for use as a non-carpeted floor covering includes vacuum forming and compression molding the integrated blank into a desired shape for use as a non-carpeted floor covering.

5. The method of claim 4 wherein the step of vacuum forming and compression molding the integrated blank into a desired shape for use as a non-carpeted floor covering further includes cooling the integrated blank to a desired target temperature.

6. The method of claim 5 wherein the step of cooling the vacuum formed and compression molded blank to a desired target temperature includes cooling to the desired temperature within about 60 seconds.

7. The method of claim 1 further including after molding the integrated blank, trimming the integrated blank to a desired dimension for use as the non-carpeted floor covering.

8. The method of claim 1 wherein the non-carpeted flooring includes a polymeric material and the under-pad includes a thermoplastic fiber blend.

9. The method of claim 8 wherein the thermoplastic fiber blend includes a blend of polyethylene terephthalate fibers.

10. A method of making a non-carpeted floor covering for a vehicle, comprising:
providing a precut non-carpeted flooring including a polymeric material, a precut under-pad including a thermoplastic material, and a precut adhesive layer;
forming a non-carpeted floor covering blank by situating the adhesive layer intermediate the non-carpeted flooring and the under-pad;
preheating the blank so that the non-carpeted flooring and underpad reach desired first target temperatures then heating the preheated blank so that the non-carpeted flooring and underpad reach desired second target temperatures to join the non-carpeted flooring and under-pad to the adhesive layer to form the integrated blank; and
vacuum forming and compression molding the integrated blank into a desired shape for use as a non-carpeted floor covering.

11. The method of claim 10 further including after vacuum forming and compression molding the integrated blank, trimming the vacuum formed and compressed blank to a desired dimension for use as the non-carpeted floor covering.

12. The method of claim 10 wherein the step of preheating the blank so that the non-carpeted flooring and underpad reach desired first target temperatures in no less than about 60 seconds then heating the preheated blank so that the non-carpeted flooring and underpad reach desired second target temperatures in no less than about 60 seconds to join the non-carpeted flooring and under-pad to the adhesive layer to form the integrated blank.

13. The method of claim 10 wherein the step of preheating the blank so that the non-carpeted flooring and underpad reach desired first target temperatures then heating the preheated blank includes heating the preheated blank so that the non-carpeted flooring and underpad reach desired second target temperatures, respectively, of about 280° F. and about 350° F. to form the integrated blank.

14. The method of claim 10 wherein the step of vacuum forming and compression molding the integrated blank into a desired shape for use as a non-carpeted floor covering further includes cooling the integrated blank to a desired target temperature.

15. The method of claim 14 wherein cooling the integrated blank to a desired target temperature includes cooling the integrated blank to the desired target temperature in about 60 seconds.

16. The method of claim 14 wherein cooling the integrated blank to a desired target temperature includes cooling the integrated blank to about 100° F.
